(19) United States
(12) Patent Application Publication
(10) Pub. No.: US 2012/0052224 A1
(43) Pub. Date: Mar. 1, 2012

(54) METHOD OF MICROWAVE COOKING OF FOOD AND IMPROVED PACKAGING MATERIAL FOR USE IN MICROWAVE OVENS

(76) Inventor: Mark Peplinski, Shropshire (GB)

(21) Appl. No.: 13/061,702

(22) PCT Filed: Sep. 1, 2009
(86) PCT No.: PCT/GB09/02109

§ 371 Date: Jul. 19, 2011

(51) Int. Cl. B32B 1/08; B05D 7/00; B05D 1/02; B32B 3/00; B05D 5/00

(52) U.S. Cl. 428/35.2; 428/143; 427/256; 427/199

(57) ABSTRACT

A packaging for microwave cooking having a plastics material film (1, 2, 3) or sheet and including a discontinuous coating of metal particles (4) applied to said film or sheet, or a disposition of discrete metal particles included in said film or sheet, wherein the small discrete particles of metal do not form a continuous layer of metal particles and/or such that they do not act as a susceptor, and such as to enable microwave cooking without undesirable reactions (such as sparks or flames) of small or individual portions of foodstuffs, and/or without undesirable hot-spot reactions with food such as may otherwise produce such.

The present invention relates to a packaging sheet material for use particularly (but not exclusively) in containers for use in microwave ovens and to a method of producing packaging for microwave cooking and a packaging for foodstuffs for use in microwave ovens and especially for small portions, and a method of microwave cooking using such.

Microwave energy in the cooking of foodstuffs in microwave ovens can sometimes produce undesirable effects.

One such undesirable effect is termed the “plasma” phenomenon where it is sometimes found with certain types of foodstuffs, such as broccoli and vegetables and particularly with small portions such as for single portions for an individual and with increasing power of microwave ovens, there is a danger that the plasma effect of the microwave oven apparatus on the foodstuff will generate sparks and/or flames which is undesirable. Previous proposals for overcoming the problem are to increase the volume of foodstuffs in the packaging although this is not desirable in certain cases as people are becoming increasingly cautious of portion size.

Another undesirable effect is termed the “hot spot” effect where spots of oil from the food overheat , especially when the oven is first switched on, and distortion appear on the inside surface of the innermost layer.

With increasingly powerful microwave ovens and ever more complex food products containing fats and oils together with salts, spices and sugars, which can cook at higher temperatures, it is sometimes found that packaging materials comprising a sheet or film of two layers bonded together, such as, a layer of Polyester (or Polypropylene, or Polyamide) bonded to a non-oriented polypropylene (or Polyethylene), which are used to contain the foodstuff while it is being cooked, can distort, melt and even rupture, and so cause significant product leakage.

This occurs because hot spots can occur, particularly in a high powered microwave oven, when small spots of oil become over-heated, due to the action of the focused microwave energy, and may distort or melt the adjacent food contact layer, which is undesirable and in extreme circumstances may lead to bursts or holes and subsequent leakage.

These distortions are at least unsightly and if they are severe enough they can cause “food contact” concerns as they can melt through to the adhesive and or ink layers, which are invariably not designed for “direct” food contact.

In the worst case, the film can melt all the way through the package and so cause leakage, which can also be dangerous due to the high temperature of the contents of the package.

According to the present invention a method of improving sheet material to be used in forming packaging for microwave cooking, including at least one plastics material film or layer (such as of polypropylene and/or polyester and/or polyamide), comprises applying to the layer a discontinuous coating of metal particles and/or metal oxide or other metallic pigment or the inclusion in the layer during formation of a discontinuous dispersion of metal particles, and/or metal oxide or metallic pigment such as to reduce or minimize or eliminate undesirable plasma effects and/or hot spots during cooking using a packaging made from such sheet material.

Also according to the present invention is the use of a coating liquid (such as metallic ink) containing discrete metal particles or metal oxide particles or metallic pigment in the reduction or prevention of undesired plasma effects when cooking small portions of food and/or reduce or prevent undesired “hot spots” effects when cooking food in a microwave oven as a coating of a layer of plastics material or other material of a container for food to be used in microwave cooking comprising applying or including said coating liquid and/or particles and/or pigment in a layer of plastics material.

Also according to the present invention an improved packaging for microwave cooking including a plastics material film or sheet, (such as of polypropylene and/or polyethylene or polyester) includes a discontinuous coating of metal particles applied to said layer or as a disposition of discrete metal particles included in said film or sheet, such as to enable microwave cooking without undesirable reactions (such as sparks or flames) of small or individual portions of foodstuffs, and/or without undesirable hot-spot reactions with food which may produce such e.g. foods with either a high fat content or with oils on the surface, for example, cheese sauce or curry sauce.

The coating may be provided to the surface of the plastics film or layer by way of a coating metallic ink painted or otherwise applied thereon, or the dispersion is applied by discrete metal particles being dispersed within the layer or during formation such that the resultant layer is a non-electrically conductive layer or arrangement or dispersion of discrete metal particles which have the unexpectedly discovered effect of preventing or minimising the generation of sparks or flames and/or hot-spots when the food is subject to the microwave effect and optionally enabling smaller quantities of certain foodstuffs to be heated safely.

It is understood that metallic inks may have previously been applied to microwave packaging for the purposes of decoration and/or information or identification, without appreciating the unexpected effect of enabling small quantities of certain foodstuffs such as broccoli and other vegetables to be safely heated. Such prior printed packaging is not believed to have been for individual portions.

Preferably the metallic ink will be printed or sprayed as a coating layer over a high percentage of the surface area of at least one layer which is to be subject to microwave energy and which would normally be the upper layer in use. It is important that the small discrete particles of metal do not form a continuous layer and such that they do not act as a susceptor.

The present invention may be utilised in respect of pouches for microwave cooking of food which may or may not be for pressurized cooking although preferably pressurized cooking with a pressure release valve incorporated therein such as disclosed in EP 0661 219.

As mentioned, metallic pigments may be added to a plastics film or layer during production thereof with a sufficient density/area coverage to provide the necessary shielding of the food (normally vegetable especially where arcing is considered) contents of the pouch whilst at the same time not forming a continuous metal layer and not forming an electrically conductive layer because of the discrete and separate metal particles.

Also according to the present invention there is provided a method of shielding small quantities of foodstuffs contained layer within microwavable foodstuff packaging, comprises applying a coating layer such as by printing or spraying metallic ink, over a surface area, preferably over a high percentage, of the packaging which is to lie between the microwave energy source and the foodstuff to be cooked.

Also according to the present invention a metallic ink whenever to be printed on to a food packaging container for use in microwave ovens to shield foodstuffs contained therein and to protect such.

Also according to the invention, the use of metallic particles or pigments or oxides as protection against to avoid or minimize “arcing” and/or hot-spots by adding such to films or material sheets or material for forming microwavable packaging for foodstuffs and also the use of any microwavable film containing metallic pigments wherein the metallic pigments are not a continuous layer and remain as discrete particles not forming nor acting as a susceptor or at least to any significant extent.

Still further according to the present invention, a method of improving packaging for microwave cooking including a plastics material film or laminate (such as of polyester and polypropylene), comprises adding or inclusion of a layer of metallic material sandwiched between the pack outer layer and the food contact surface which acts as a “protective” layer and reduces the “plasma” phenomenon, and also the “hot-spot” effect.

The protective layer acts to reduce the “peaks” of energy that are seen by the food when the microwave is first turned on. The protective layer slightly shields the product from the highest energy wavelengths. It is still transparent to the bulk of the microwave energy and as such does not prevent the product from being heated by the microwave energy in the conventional way.

The protective layer may be selected from one or more of the following:
(1) a layer of metallic ink (metallic flake pigment e.g. aluminium);
(2) a layer of metallic pigment introduced as a masterbatch in a film;
(3) a layer of highly pigmented PET or PP film—pigment being a metallic oxide; e.g. a titanium dioxide (TiO2);
(4) a layer of printed ink and titanium dioxide (TiO2) at high levels; and/or
(5) a layer of evaporation coated aluminium oxide.

The invention will be described further, by way of example, with reference to the accompanying drawings, in which:

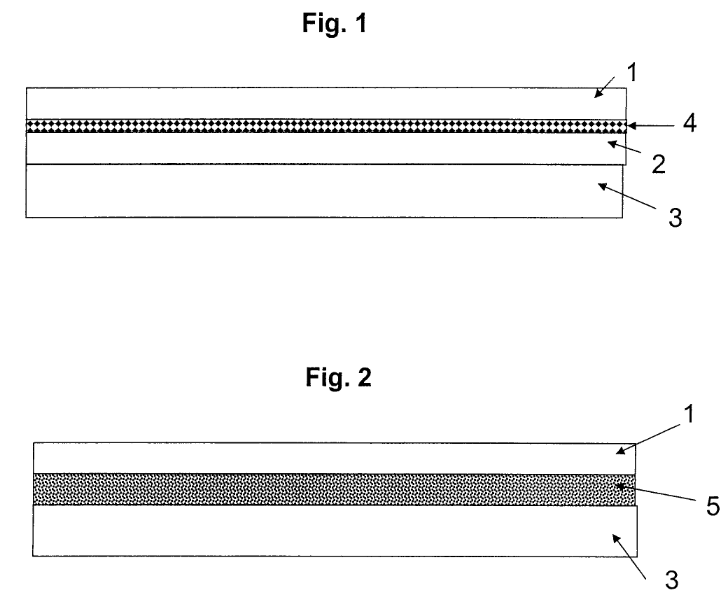

FIG. 1 is a schematic illustration of a first embodiment according to the invention comprising a section through a wall having three film layers of a plastics material pouch for containing food for cooking in a microwave oven;

FIG. 2 is a similar schematic illustration of a second embodiment according to the invention;

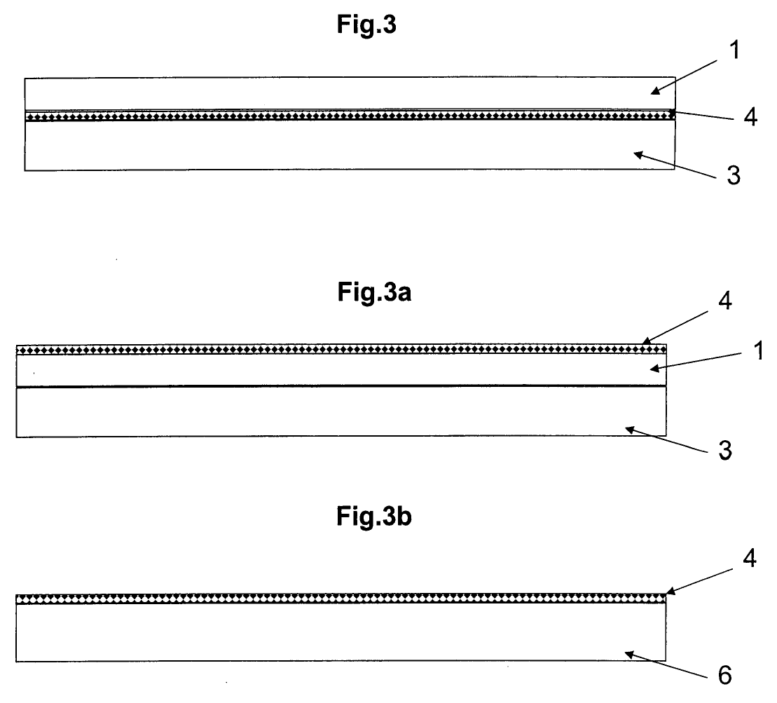

FIGS. 3 and 3a are schematic sectional illustrations of two layer embodiments in contrast to the three layer embodiment shown in FIG. 1;

FIGS. 3a and 3b are schematic illustrations of embodiments having the ink/coating on the surface as opposed to such being trapped between layers (FIG. 3 being a laminate whereas FIG. 3b being a straight forward—mono-layer film);

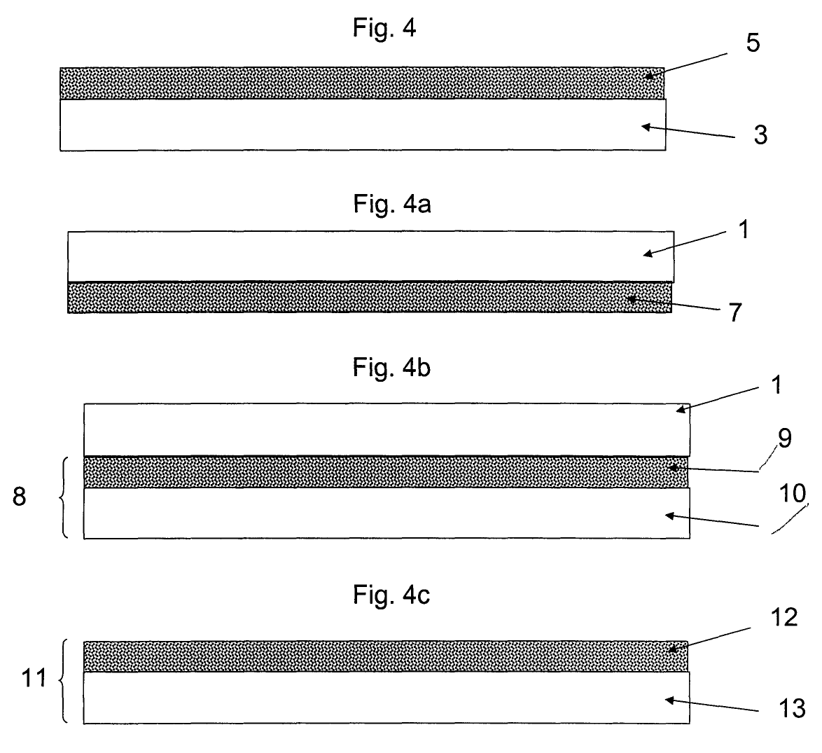

FIGS. 4, 4a, 4b and 4c are schematic illustrations of modifications of the embodiment of FIG. 2 with metallic pigment within the film;

FIG. 4 is a schematic section similar to FIG. 2 but with the top layer 1 omitted;

FIG. 4a is a schematic illustration of an embodiment maintaining the top surface as PET and with the metallic pigment/metal oxide pigment being in the PP/PE layer;

FIG. 4b is a schematic illustration similar to FIG. 4a with the lower layer being the polypropylene/polyester film; and

FIG. 4c is a schematic section through a monolayer film version forming a further embodiment of the invention.

In the drawings generally the same reference numbers are used for the same component layers which in the various embodiments are located in different relative positions wherein:

Layers 1 and 2 are outer and adjacent plastics material layers such as of polyester (PET) or polypropylene (PP);

Layer 3 is an inner layer such as of polypropylene;

Layer 4 is a metallic coating such as of a metallic ink;

Layer 5 is a plastics material layer of highly pigmented polyester or polypropylene with the pigment being a metallic oxide such as titanium oxide.

In FIG. 1 there is illustrated a section through one wall of a sealable rectangular pouch for containing food (not shown) for cooking in a microwave oven under pressure.

The pouch is formed from a composite/laminate film or sheet of plastics material forming opposite side walls (only one shown) and a closable/sealable access mouth (not shown) and each wall itself is formed of layers bonded together by adhesive (not shown). In the example there are three films or sheets, namely a normally outer layer of polyester or polypropylene, for example, which is to be closest to the exterior, a middle layer 2 of polyester or polypropylene, for example, and an inner layer 3 of e.g. polypropylene which may have a steam/air escape slot or slit (not shown) indicated as part of or leading to a pressure release valve (not shown)—and such as disclosed in EP 0661219.

Between layers 1 and 2 a protective layer of microwave influencing material which may act to reduce “peaks” of energy that are otherwise received by the food when the microwave is first turned on and/or shield the food product from the highest energy wavelengths and/or diffuse such. The protective layer may be a layer of metallic material 4 sandwiched between layers 1 and 2 and in the example is a layer of metallic ink e.g. containing aluminium flake pigment.

In the embodiment of FIG. 2, middle layer 5 is modified in its production by being formed as a layer of highly pigmented polyester or propylene with the pigment being a metallic flake pigment similar to that in FIG. 1 above, or in its simplest and cheapest form it could be a metallic oxide such as titanium dioxide (TiO2).

It is envisaged that an embodiment comprising a combination of the sandwiched layer of FIG. 1 and the pigment layer of FIG. 2 is also possible.

It is also envisaged that selected areas and/or sides of the pouch may have the protective layer.

In FIGS. 3, 3a, 3b and FIGS. 4, 4a 4b and 4c are schematic illustrations of different embodiments which are usually simpler and cheaper.

In FIGS. 3 and 3a the same reference numerals are used for the same components as in FIG. 1 and are two layer embodiments including metallic ink layer 4 (which could instead be a pigmented layer) as opposed to the three layer option shown in FIG. 1.

FIGS. 3a and 3b have the metallic ink or metal layer coating on the surface as opposed to such being trapped between layers. FIG. 3a is also a laminate whereas FIG. 3b is a straight forward mono-layer film—which would obviously need to be different than the PP/PE films used in the past as layer 3 and hence may be given it the reference number 6.

In FIGS. 4, 4a, 4b and 4c further embodiments are illustrated and adaptations of that of FIG. 2 with the metallic pigment within the film layer 5;

FIG. 4 is a similar embodiment to that of FIG. 2 but with layer 1 omitted;

In the embodiment of FIG. 4a the top surface PET is maintained and has metallic pigment/metal oxide pigment in the PP/PE layer 7 (Hence new no 7);

FIG. 4b is a further embodiment generally the same as that of FIG. 4a with 8 being the PP/PE film. What is attempted to be shown is that in layer 7 the additive is throughout the films and in combination 8 such is in discrete layers of the film. This would mainly be for other purposes e.g. sealing performance, food contact approval etc. Layer 9 is the pigmented layer and lower layer 10 contains no pigment;

FIG. 4c is a schematic section through a monolayer film embodiment (where layer 11 is generally the same as in 8 above—but may need to be different). Layer 12 is the layer with the pigment and layer 13 the one without. One might again have more layers e.g. 3 or 4 or 5 layers.

It should be noted that wherever the metallic ink/coating has been shown in FIGS. 1 and 3, then this is also the position where the clear aluminium oxide layer referred to in the paragraph above before the introduction to the drawings is found.

1. A packaging for microwave cooking having a plastics material film or sheet and including a disposition of discrete metal particles included in said film or sheet or a coating of discontinuous, discrete metal particles applied to said film or sheet, wherein in said film or sheet or in said coating the small discrete particles of metal do not form a continuous layer of metal particles and/or such that they do not act as a susceptor, and such as to enable microwave cooking without undesirable reactions (such as sparks or flames) of small or individual portions of foodstuffs, and/or without undesirable hot-spot reactions with food such as may otherwise produce such.

2. A packaging as claimed in claim 1 in which the film is of polypropylene and/or polyethylene and/or polyester.

3. A packaging as claimed in claim 1 in which the coating is provided on the surface of the plastics film or layer by way of a coating of metallic ink painted or otherwise applied thereon, or in which the disposition of discrete metal particles are dispersed within the layer or during formation such that the resultant layer is a non-electrically conductive layer or arrangement or dispersion of discrete metal particles.

4. A packaging as claimed in claim 1, in which the metallic ink is printed or sprayed as a coating layer over a high percentage of the surface area of at least one layer which is to be subject to microwave energy and which is normally the upper layer in use.

5. A packaging as claimed in claim 1, which is a pouch for microwave cooking of food which pouch may or may not be for pressurized cooking.

6. A packaging as claimed in claim 5, which is a pouch for use in pressurized cooking and includes a pressure release valve incorporated therein.

7. A packaging as claimed in claim 1, in which metallic pigments are added to a plastics film or layer during production thereof with a sufficient density/area coverage to provide the necessary shielding of the food contents of the pouch including such whilst at the same time not forming a continuous metal layer and not forming an electrically conductive layer because of the discrete and separate metal particles.

8. A packaging as claimed in claim 1, in which protective coating at disposition is selected from one or more of the following:
(1) a layer of metallic ink (metallic flake pigment e.g. aluminum);
(2) a layer of metallic pigment introduced as a masterbatch in a film;
(3) a layer of highly pigmented PET or PP film—pigment being metallic oxide; e.g. a titanium dioxide (TiO2);
(4) a layer of printed ink and titanium dioxide (TiO2) at high levels; and/or
(5) a layer of evaporation coated aluminum oxide.

9. A method of improving sheet material to be used in forming packaging for microwave cooking, including at least one plastics material film or layer (such as of polypropylene and/or polyester polypropylene), comprises applying to the layer a discontinuous coating of metal particles and/or metal oxide or other metallic pigment, or comprising the inclusion in the layer during formation of a discontinuous dispersion of metal particles, and/or metal oxide or metallic pigment such as to reduce or minimize or eliminate undesirable plasma effects and/or hot spots during cooking using a packaging made from such sheet material.

10. A method of shielding small quantities of foodstuffs contained layer within microwavable foodstuff packaging, comprises including discrete metallic particles as a dispersion within a film or applying a coating layer such as by printing or spraying metallic ink, over a surface area, preferably over a high percentage, of the packaging which is to lie between the microwave energy source and the foodstuff to be cooked.

11. (canceled)

12. (canceled)

13. (canceled)

14. (canceled)

15. (canceled)
